(19) United States
(12) Patent Application Publication
(10) Pub. No.: US 2026/0335939 A1
(43) Pub. Date: Oct. 29, 2026

(54) METHOD AND DEVICE FOR SINGULATING A PACKAGED PRODUCT BY MEANS OF A ROBOTIC ARM

(71) Applicant: ROBOMINDS GMBH, München (DE)

(72) Inventors: Tobias RIETZLER, München (DE); Manfred RIETZLER, Bangkok (TH); Andreas DÄUBLER, Landsberg am Lech (DE); André BRONOLD, München (DE)

(21) Appl. No.: 19/491,127

(22) PCT Filed: Jun. 4, 2024
(86) PCT No.: PCT/EP2024/065275

§ 371 Date: Apr. 28, 2026

(30) Foreign Application Priority Data
Jun. 15, 2023 (DE) 10 2023 115 733.7

(51) Int. Cl. B07C 5/36; B25J 9/16

(52) U.S. Cl. CPC B07C 5/362; B25J 9/1679

(57) ABSTRACT

A method for singulating packaged goods, a matrix of measured values representing packaged goods first being created by a sensor for determining an expansion, a state of coverage, a position and/or an orientation of at least one particular good by means of inference of the matrix of measured values with a statistical model and/or by means of an approximation method is provided. The expansion, state of coverage, position and/or orientation is taken into account when creating a set of control data for at least one robotic arm, the movement performed according to the set of control data comprising gripping and singulating by a pulling movement. Furthermore, a device for singulating packaged goods includes at least a robotic arm, at least one sensor, and a computer system. Furthermore, a computer program product includes sections of software code that are developed in such a way that the method can be carried out by at least one processor.

The invention relates to a method for singulating packaged goods by means of at least one robotic arm according to claim 1 and a device comprising a robotic arm for singulating packaged goods according to claim 10.

Robots, which pick up packaged goods by means of a robotic arm and a correspondingly suitable gripper from a pile of packaged goods, raise it to a prescribed placement location and place it there (referred to as pick & place robots) are known in the prior art. In this context, it is important that the robot's gripping action and the subsequent movements performed together with the object are adapted to the packaged good in such a way that it is not damaged. In particular, a gripping force that is too strong or too weak can damage the packaged good by crushing or dropping it. The manner in which the packaged good must be held in order to avoid damage is largely object-specific. In particular, identification of the packaged goods is undesirable and/or illegal if the packaged goods are postal items. However, the problem then arises that, for example, the weight and/or properties of the packaged goods is also unknown. Therefore, there is always a risk of damage.

There is therefore a great need for a method and a device for singulating packaged goods, the packaged good generally preferably not being known and/or identified beforehand and/or later.

Handling of the packaged good should be as reliable, safe, smooth and fast as possible, without delay, deceleration or interruption. In addition, the method should be cost-effective to implement, and the device should be cost-effective to produce and operate, with a further focus being on making it as compact and space-saving as possible. The invention has set itself the task of providing such a method and such a device and thereby overcoming the disadvantages in the prior art with the smallest possible space requirement possible.

This problem is solved in a surprisingly simple but effective way by a method for singulating packaged goods according to the teaching of independent main claim 1 and a device comprising a robotic arm for singulating packaged goods according to the teaching of claim 10.

According to the invention, a method for singulating packaged goods by means of a robotic arm is proposed, the method comprising the following steps:
a. detecting at least one matrix of measured values of packaged goods by means of at least one sensor;
b. determining an expansion, a state of coverage, a position and/or an orientation of at least one particular good of the packaged goods by inference with a statistical model and/or by means of an approximation method with entry of the matrix of measured values;
c. creating a set of control data for the robotic arm taking into account the expansion, state of coverage, position and/or orientation of the particular good;
d. grasping the particular good by means of the robotic arm according to the set of control data; and
e. singulating the particular good from the other packaged goods with at least one pulling and singulation movement according to the set of control data by means of the robotic arm.

It has been recognized in the context of the invention that singulation of unknown and packaged goods by means of lifting regularly fails because the packaging and/or the packaged good are either damaged by excessive gripping force of the gripper arranged on the robotic arm or by falling down due to insufficient gripping force. In the context of the invention, it has further been recognized that the gripping force can be significantly reduced if the particular good is not lifted, but rather is singulated by means of a pulling movement directed away from the other packaged goods on a surface on which the packaged goods are placed. In the context of the invention, it has been recognized that the movement is preferably an optimized movement in the direction of traction. On the one hand, less gripping force is required for this purpose than for lifting the particular good. On the other hand, if the gripping force is too low, the particular good does not fall, but simply remains in its current position. It is then possible for the gripper to grasp the particular good again and continue executing the method. It has also been recognized that singulation can already be achieved with short pulling distances and, in particular, that it is not necessary to deposit the particular object gently, as a result of which the method can be carried out quickly and effectively as well as in a space-saving manner.

In an initial position, there are at least two packaged goods in a pile-like arrangement. Preferably, there are at least 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 identical and/or different packaged goods in a pile-like arrangement. The terms “packaged good” and “particular good” are understood by a person skilled in the art and, for example, relate to, but by no means exclusively, a parcel, a small parcel, a postal item, a document sent by post, a letter sent by post, a piece of luggage such as a suitcase and a bag, a crate, a carton, a box and/or a bulky good.

In order for singulation of the packaged goods to be possible at all, the packaged goods must first be detected in step a. The packaged, delivered goods are detected by measuring and creating a matrix of measured values by means of the at least one sensor. Here, it is obvious to a person skilled in the art that the packaged goods are partially or fully detected. It is conceivable that the measured values for the matrix of measured values are detected by the sensor simultaneously or consecutively. It is also conceivable that the sensor is part of a measuring device with a data processing device and that the measuring device creates the matrix of measured values by calculation using the individual measured values determined by the sensor, in particular while the sensor moves. Preferably, the measured values from at least 2, 3, 4, 5, 6, 7, 8, 9, 10, 11, 12, 13, 14, 15, 16, 17, 18, 19 or 20 similar and/or different sensors are detected simultaneously or consecutively. Further preferably, at least 2, 3, 4, 5, 6, 7, 8, 9, 10, 11, 12, 13, 14, 15, 16, 17, 18, 19 or 20 identical or different measured value are measured by the sensors. Even more preferably, at least 2, 3, 4, 5, 6, 7, 8, 9, 10, 11, 12, 13, 14, 15, 16, 17, 18, 19 or 20 sensors detect at least one measured value.

The term “singulation” or “to singulate” relates to the removal and/or separation of the particular good from the other packaged goods so that it is isolated from the other packaged goods.

The term “measured value” refers to the quantization, the manifestation and/or the digitization of a property of the arrangement of the packaged goods.

The term “matrix of measured values” relates to a data structure that is used to store and organize the measured values, the data structure consisting of a two-dimensional array in which the measured values are arranged in rows and columns. The two dimensions correspond to the spatial directions of the surface on which the packaged goods are arranged, it being possible to assign one or multiple measured values to each spatial point of the two dimensions.

In step b., the matrix of measured values created in step a. is entered into a statistical model and/or determined by means of an approximation method. The statistical model and/or the approximation method was trained by means of sets of training data before and/or is trained during the execution of the method. The sets of training data can be created simulatively and/or consist of real process data. The statistical model infers and/or the approximation method ascertains an expansion, a state of coverage, a position and/or an orientation of at least one particular good. The statistical model preferably interferes and/or the approximation method ascertains the expansion, state of coverage, position and/or orientation of all the packaged goods detected in the matrix of measured values.

Here, the particular goods can be selected randomly from the detected goods in order to enable handling that is as fast as possible. The statistical model is preferably a statistical data model that is created with the aid of an approximation method, in particular deep learning, convolutional neural network (CNN), recursive nets (RNN), generative adversarial networks (GAN), stochastic machine, random forest or support vector machine.

The term “expansion” relates to the geometric shape of the packaged good.

The term “state of coverage” relates to the degree of coverage of a packaged good that is covered by one or multiple other packaged goods.

The term “position” relates to the location and/or position of a packaged good in relation to a reference point and/or a coordinate system. The reference point and/or the coordinate system can refer to the surface on which the packaged goods are arranged, to the position of the robotic arm or to other, in particular neighboring, packaged goods.

The term “orientation” relates to the orientation of the packaged goods in relation to the surface on which the packaged goods are arranged, taking into account the expansion of the packaged good.

In step c., a set of control data is created for the robotic arm, taking into account the state of coverage, position and/or orientation of the particular good. The set of control data is particularly preferably created in such a way that the direction of the later movement by means of the position takes place in the direction of the shortest distance from an edge of the surface, in the direction of the smallest state of coverage and/or in the direction of the smallest degree of tilt determined from the orientation. The set of control data is particularly preferably created by inference with the statistical model or by means of inference with another statistical model and/or by means of the approximation method. The statistical model and/or the approximation method was trained by means of sets of training data with reference to the set of control data before and/or is trained during the execution of the method. Further, a prescribed end position of the particular goods can be taken into account when creating the set of control data. The sets of training data preferably comprise expansions, states of coverage, positions and/or orientations of packaged goods in pile-like arrangements of packaged goods and assigned optimal and/or correct sets of control data by way of example. Even more preferably, an optimal and/or correct set of control data is created by inference. It is conceivable that the statistical model and/or the approximation method infer the at least one, preferably optimal and/or correct, set of control data from the expansion, the state of coverage, the position and/or the orientation of the packaged good that best matches the packaged good of a training file serving as an example. Even more preferably, it is conceivable that the statistical model and/or the approximation method infers the at least one, preferably optimal and/or correct, handling property from the fact that the expansion, the state of coverage, the position and/or the orientation of the packaged good best match individual sets of training data and the sets of control data stored for the individual training measured values are connected to form an optimal and/or correct set of control data. In other words, the inference of the statistical model and/or the approximation method correspond to the at least one set of control data of a particular set of training data, or the set of control data is formed by inference from different sets of control data of different sets of training data. The advantage of the first approach is that the set of control data is guaranteed to have a logical structure. The advantage of the second approach is that the set of control data is more individual and therefore potentially more optimally and/or more correctly matched to the situation at hand. In addition to the expansion, the state of coverage, the position and/or the orientation of the particular good, it is also conceivable that other information outside the particular good is taken into account. The information can preferably relate to the robotic arm, in particular a state of the robotic arm, the environment in which the method is carried out, in particular a state of the environment, and/or the user, in particular specifications of the user employing the method. The set of control data specifies movement sequences, which it is supposed to execute, to the robotic arm. In the context of the invention, at least one robotic arm is provided, preferably 2, 3, 4, 5, 6, 7, 8, 9, 10, 11, 12, 13, 14, 15, 16, 17, 18, 19 or 20 similar and/or different robotic arms arranged side by side or one behind the other.

The term “optimal and/or correct set of control data” relates to a set of control data that a reasonable and knowledgeable person skilled in the art who recognizes the pile-like arrangement of the packaged goods and, in particular, the expansion, state of coverage, position and/or orientation of the particular goods, would classify as optimal and/or correct in the given environment in which the method is carried out.

In step d., the robotic arm grasps the particular good according to the set of control data. This means that the robotic arm picks up the particular good by means of the gripper.

In step e., the robotic arm singulates the particular good from the other packaged goods with at least one pulling and singulating movement. This means that the particular good is pulled away from the other particular goods in a laterally directed movement. As the particular good is not lifted, it is possible to reduce the gripping force and effectively prevent it from falling down. Furthermore, the loads on the packaging of the packaged goods are also reduced, so that they are exposed to the risk of ripping open to a lesser degree. It is conceivable to have the method carried out multiple times in succession or simultaneously with multiple robotic arms, each with different particular goods, until a portion of or all of the packaged goods are singulated.

The method according to the invention can be repeated as often as desired and can be carried out in a fully or partially automated manner. It has been recognized that each particular good passes through the steps essential to the invention, these being dependent on the particular good.

The method according to the invention makes it possible to automatically singulate a particular good using a robotic arm in a simple, fast and easily adaptable manner. The method can be implemented inexpensively and is safe with regard to handling of the goods and their packaging. The method is therefore reliable, fast, safe and also space-saving.

Advantageous further developments of the invention, which can be realized individually or in combination, are presented in the subclaims.

It is conceivable that the movement is essentially horizontal in step e. In this way, it is possible to drastically reduce the pulling and/or traction force acting on the packaged good, in particular due to the fact that the weight of the good is reduced because it partially or fully rests on the surface on which the packaged goods are placed. The loads on the packaging of the packaged goods are thus reduced so that they are exposed to the risk of ripping open to a lesser degree.

The term “essentially” means that there is only a small, in particular non-significant, alteration, change and/or deviation from the corresponding conditions. With reference to the movement, “essentially horizontal” means that the small, in particular non-significant, deviation from the horizontal movement, such as, for example, due to the different height and/or orientation of the surfaces on which the packaged goods are placed, a conveyor belt and/or a continuous conveyor, is irrelevant and is therefore compensated for.

In an advantageous further development of the method, packaged goods and/or the particular good are transported before, during and/or after steps a. to e. In the context of the invention, it has been recognized that the singulation in particular serves to distribute the packaged goods. The singulated packaged goods are supposed to be brought to different locations so that further transport of the singulated goods following the process is achieved as a result. Removal of the singulated goods is also advantageous, so that additional singulated goods can then be brought to the vacated position and the singulated movement can be kept small. Transport before the process enables a continuous supply of goods to be singulated so that the process can be carried out without interruption and with a correspondingly high throughput. Therefore, additional time savings can be achieved if the process takes place before, during or after the transport of the particular goods and/or the packaged goods.

In a further development, it is conceivable that the number of packaged goods delivered and the number of packaged goods removed are measured, in particular after singulation, and in the event that the number of packaged goods delivered is greater than the number of packaged goods removed, the transport of the packaged goods, in particular the delivery, is interrupted, the transport of the packaged goods, in particular the removal, is increased and/or the delivery and removal are matched to each other. If the number of packaged goods removed is less than the number of packaged goods delivered, jamming occurs and the process can no longer be carried out safely and reliably. If the delivery is temporarily or briefly interrupted, the outgoing transport is temporarily or briefly increased and/or the incoming transport and outgoing transport are matched to each other, the congestion can be cleared by the method. The transport can subsequently be resumed. A person skilled in the art is familiar with suitable methods and measures for temporarily or briefly interrupting transport, increasing transport and/or matching these to each other.

Furthermore, it is advantageously conceivable that the robotic arm is moved at a speed relative to the speed of transport of the packaged goods. Matching of the speed of transport and the speed of movement of the packaged goods is achieved as a result, thereby minimizing the load on the packaged goods or the packaging of the packaged goods. It is conceivable that the relative speed affects the entire robotic arm. This means that the robotic arm is transported together with the packaged goods at least in sections. Alternatively, only the gripper can be moved at the relative speed with the packaged goods, which is made possible by appropriately matched movements of the rest of the robotic arm.

Advantageously, it is also conceivable that the robotic arm rotates the particular good by an angle of rotation and/or tilts it by a degree of tilt on the essentially horizontal plane before and/or during step e. The contact area between the particular good and the surface on which the packaged goods are arranged is reduced as a result, and a reduced frictional force results between the particular good and the surface when the pulling, essentially horizontal and singulating movement in step e. is carried out. The load on the particular good or the packaging of the particular good is therefore further reduced and can also be determined and/or adjusted. Preferably, the angle of rotation is at least 1°, 2°, 3°, 4°, 5°, 6°, 7°, 8°, 9°, 10°, 12.5°, 15°, 17.5°, 20°, 25°, 30°, 35°, 40°or 45°. Also preferably, the degree of tilt is at least 1°, 2°, 3°, 4°, 5°, 6°, 7°, 8°, 9°, 10°, 11°, 12°, 13°, 14°, 15°, 16°, 17°, 18°, 19°, 20°, 25°, 30°, 35°, 40°or 45°. Even more preferably, the particular good is tilted by the degree of tilt and lifted by at least 0.5 mm, preferably at least 1 mm, 2 mm, 2 mm, 3 mm, 4 mm, 5 mm, 6 mm, 7 mm, 8 mm, 8 mm, 9 mm or 10 mm, or maximal 10 mm, preferably maximal 9 mm, 8 mm, 7 mm, 6 mm, 5 mm, 4 mm, 3 mm, 2 mm, 1 mm or 0.5 mm. In this way, the frictional force resulting in step e., in particular the frictional force on the edge of the good located on the surface, is further decreased and can be determined and/or adjusted in such a way that the load on the particular good or the packaging of the particular good is therefore further reduced. This is due to the fact that the weight of the goods is reduced, which is particularly useful for large, heavy, coated, sticky, wet and/or film-wrapped goods due to their increased adhesion to the surface on which the packaged goods are placed.

In yet another further development, it is conceivable that the particular good is turned one or more times before and/or during step e. This makes it possible to identify the good because it can be positioned by one or repeated turns around the longitudinal and/or transverse axis in such a way that the identification, inscription, marking and/or labeling is legible and/or recognizable.

Moreover, it is advantageously conceivable that a handling property of the particular good is determined by querying the matrix of measured values, a section of the matrix of measured values and/or another measured value of another sensor in a database and/or inference with the and/or another statistical model and/or the approximation method, the handling property being a target address, a grip strength, a point of contact, an orientation, a selection of a gripper, a pulling speed and/or a pulling strength. In the context of the invention, it has been recognized that other handling properties are conceivable depending on the type of packaged good and/or the packaging of the packaged good. In particular, goods packed in bags require higher grip strength and/or a different gripper than goods packed in cardboard. The grippers available for selection preferably comprise a suction gripper, a magnet and/or a mechanical gripper, in particular a pincer gripper, a three-finger gripper and/or a four-finger gripper. Further, one, two, multiple or all grippers can be arranged on the robotic arm at the same time and/or it can be possible to change the grippers. In this way, the gripping movement and/or the gripper can be optimally adapted to the particular good and the load can be kept to a minimum. It is conceivable that the matrix of measured values, the section of the matrix of measured values and/or the other measured value comprises a legible, in particular a machine-readable, reference, in particular a code. A barcode and/or a QR code is preferably conceivable.

It is preferably conceivable that the steps of the method take place continuously or in discrete time. Continuous execution enables a high throughput and therefore big time savings, while discrete-time execution offers a high level of process reliability. It is conceivable that a portion of the steps takes place continuously and another portion of the steps takes place in discrete time. Further preferably, it is conceivable that a selection between a continuous and a discrete mode can be made. In this way, the method can be adapted to the packaged goods at hand, the environment and/or an initial situation.

Furthermore, it is advantageously conceivable in step b. that the expansion, the state of coverage, the position and/or the orientation of at least two detected goods are ascertained from the packaged goods by means of inference with the and/or another statistical model and/or the approximation method with entry of the matrix of measured values and that a particular good is selected from the packaged goods. In the context of the invention, it has been recognized that, with the pile-like arrangement of the packaged goods in the situation appearing, one or more packaged goods are more likely to be suitable for carrying out the method according to the invention on them than others due to their expansion, state of coverage, position and/or orientation. This can occur, for example, as a result of the fact that the more suitable packaged goods are closer to one edge of the pile-like arrangement than the others. It is therefore efficient to carry out the method according to the invention on these first. Preferably, the expansion, the state of coverage, the position and/or the orientation of all goods detected in the matrix of measured values are ascertained by means of inference with the and/or another statistical model and/or the approximation method with entry of the matrix of measured values.

Furthermore, it is advantageously conceivable that the method comprises another step f., namely analyzing the singulation and obtaining an evaluation, and optionally displaying the evaluation. This evaluation makes it possible to assess the quality of the singulation. Advantageously, it also becomes possible to provide sets of training data created from the evaluation to extend and/or update the statistical model and/or the approximation method. In this way, the singulation can be continuously optimized during operation. In particular, the statistical model and/or the approximation method can be continuously trained, improved and/or adapted through the evaluation, so that the optimal and/or correct handling property can be inferred with a higher probability by means of the statistical model for new situations not contained in the training data when the method according to the invention is repeated. It is conceivable that the evaluation is carried out by means of the existing sensors and/or by means of sensors specially installed for the evaluation.

It is assumed that the definitions and explanations of the above-named terms apply to all aspects described in this description in the following, unless otherwise stated.

In accordance with the invention, a device for handling objects comprising a robotic arm, at least one sensor and a computer system is further proposed, the computer system comprising a computer-readable storage medium comprising a statistical model and/or an approximation method for carrying out step d. of a method described elsewhere and preferably carried out by the device and at least one data processing system for carrying out steps b., c and d. of the method described elsewhere. The advantageous method, along with the advantages described there, can be carried out by means of the device according to the invention. Particularly preferably, the device comprises at least 2, 3, 4, 5, 6, 7, 8, 9, 10, 11, 12, 13, 14, 15, 16, 17, 18, 19 or 20 identical or different sensors and/or 2, 3, 4, 5, 6, 7, 8, 9, 10, 11, 12, 13, 14, 15, 16, 17, 18, 19 or 20 identical or different robotic arms. Even more preferably, the computer readable storage medium comprises the one or more statistical model(s) described elsewhere and/or the database described elsewhere and/or the approximation method described elsewhere. The device according to the invention is fully or partially automated.

It is also conceivable that the sensor is part of an image acquisition device, in particular a 3D camera, a lidar, a radar, a tactile sensor system, a spectrometer, an ultrasonic measuring device, an X-ray device, a distance measuring device and/or a refractometer. In principle, any type of sensor for measuring the measured value can be used, as long as it meets the requirements of the claims according to the invention and can detect a measured value that is suitable according to the invention for a matrix of measured values that is suitable according to the invention. Which object property is suitable according to the invention depends to a large extent on the intended purpose of the device. The sensors and/or devices mentioned above are particularly suitable for one or more specific purposes. The corresponding purposes and the sensors and/or devices suitable for them are apparent to a person skilled in the art.

Furthermore, it is conceivable that the device comprises another sensor, the other sensor being a light sensor, a force torque sensor, a vacuum sensor, a force sensor, a rotary encoder, a torque sensor or a pressure sensor or being part of a device, in particular of a barcode scanner, an RFID scanner, or of a measuring device, in particular of a thermometer, an explosives measuring device, a hazard measuring device, a humidity measuring device and/or a scale. The other sensor is suitable for detecting the other measured value described elsewhere for determining at least one handling property in order to achieve the advantages described there. The additional sensor can also be arranged on and/or in the gripper and evaluate the movement. In particular, the other sensor can detect whether the gripper loses the particular good. In this case, it is possible to correct the set of control data. The sensor can also detect explosives and/or hazardous materials and single out packaged goods containing explosives and/or hazardous materials.

In a further development of the invention, it is conceivable that the robotic arm has one axis or multiple axes. A single-axis robot has the advantage that it is easier to control and monitor. A multi-axis robot, on the other hand, can cover a larger area of accessible packaged goods and, in particular, grip and singulate them in a more correct and/or optimal way. Particularly preferably, the robotic arm is guided on a rail. Further, it is conceivable that the robotic arm comprises in each case at least one, preferably in each case 2, 3, 4, 5, 6, 7, 8, 9, 10, 11, 12, 13, 14, 15, 16, 17, 18, 19 or 20 identical or different suction grippers, a magnet and/or a mechanical gripper, in particular a pincer gripper, a three-finger gripper and/or a four-finger gripper.

It is also conceivable that the device comprises at least one continuous conveyor and/or a load carrier. In this way, the transport of the packaged goods described elsewhere can be achieved before, during and/or after steps a. to e. along with the advantages described there. Further preferably, the device comprises at least 2, 3, 4, 5, 6, 7, 8, 9 or 10 continuous conveyors running at the same and/or different speeds and/or running in the same and/or different directions. It is preferably conceivable that the particular good is pulled onto a predetermined continuous conveyor during singulation.

Particularly preferably, the load carrier has an openable and/or open side wall.

In a further development of the invention, the device comprises a provision surface. On the provision surface, the packaged goods are arranged in the arrangement with piles on the provision surface to carry out the method. Particularly preferably, the provision surface is constructed in such a way that it has the lowest possible adhesive friction, high abrasion resistance and/or scratch resistance. The provision surface is particularly preferably made of stainless steel.

It is also conceivable that the computer system comprises an interface and/or a network connection. The network can be an intranet consisting of at least one other computer system and/or the internet. The interface and/or the network connection make it possible to provide the computer system with sets of training data and/or database entries for creation. Likewise, entries and/or updates in the database, in particular handling properties, can be carried out by means of the interface and/or the network connection. Further, it is conceivable that the database is partially or completely located outside the computer system and that the computer system is connected to the database by means of the network. The manner in which the entries and/or updates are created for the database is basically arbitrary. It is preferably conceivable that the entries and/or updates result from the measured values detected by the computer system, as described elsewhere. Even more preferably, it is conceivable that the database can be updated and/or expanded by at least one other identical or different computer system that is also capable of detecting measured data and/or by storage during production and/or a detection of the packaged goods. In particular, it may be the database described elsewhere that serves for general networking and digital accessibility. Further, it is possible to provide sets of training data for training the statistical model and/or the approximation method by means of the interface and/or the internet port. This enables safe, correct and/or optimal handling of individual objects in advance. In particular, destination addresses can be forwarded to the computer system by means of the interface and/or a network connection.

In a further development of the invention, it is conceivable that the device is a parcel sorting system and the packaged goods, for example, are postal items, as described in detail elsewhere. Which type of packaged goods the method according to the invention is applied to is basically arbitrary.

However, postal items are packaged goods that must be regularly singulated for onward transport.

They are also shaped differently, have different packaging, their contents are unknown and they have different destination addresses. Therefore, the advantages that can be achieved with the method and/or device according to the invention are particularly suitable for a parcel sorting system.

Further proposed according to the invention is a computer program product comprising sections of software code that are developed in such a way that a method described elsewhere can be carried out by at least one processor. The advantages described elsewhere are achieved as a result.

Further details, features and advantages of the invention will become apparent from the following description of the preferred embodiment in conjunction with the sub-claims. In this respect, the respective features can be realized individually or in combination with each other. The invention is not limited to the embodiment. The embodiment is shown schematically in the figures.

In detail

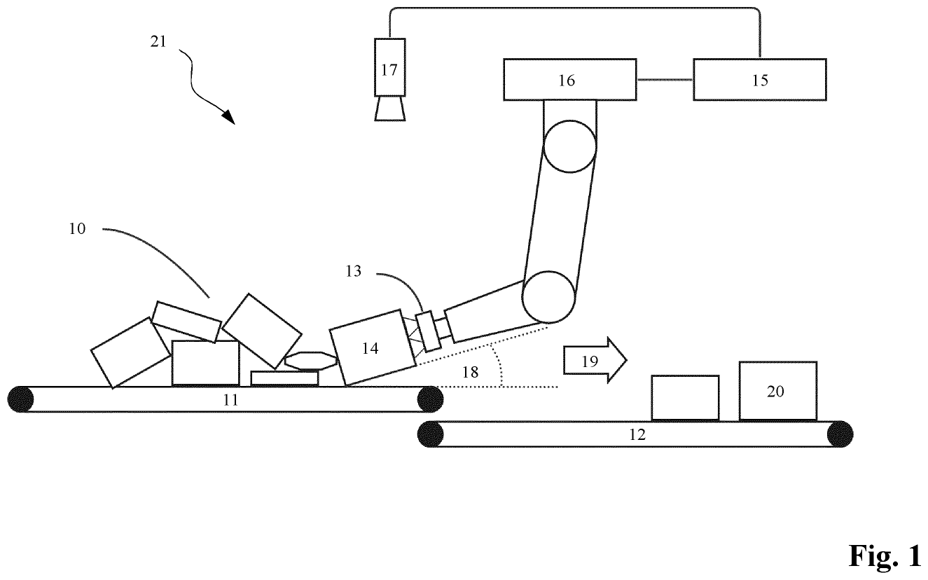

FIG. 1 shows a schematic side view of a device according to the invention.

FIG. 1 shows a schematic side view of a device according to the invention 21. The device 21 is a parcel sorting system. The device includes a robotic arm 13, at the end of which a gripper is arranged. In FIG. 1, the robotic arm is designed with two axes. There are multiple, differently designed packaged goods 10 in a pile-like arrangement on the left of the figure. The packaged goods 10 are postal items. The packaged goods 10 lie on a first continuous conveyor 11, which transports the packaged goods 10 into the area of a sensor 17. The sensor 17 is developed as a 3D camera. The sensor 17 detects the packaged goods 10 and creates a matrix of measured values, the matrix of measured values being a 3D image. An extension, a state of coverage, a position and/or an orientation of all detectable packaged goods 10 is first created from the matrix of measured values by means of a statistical model executed on a computer system 15. These are the packaged goods 10 that can be detected by the sensor 17 because they are at least partially not covered. From this, a particular good 14 is interfered by the statistical model. In the present case, this is the packaged good 10, which is on the right in FIG. 1, as it is closest to the gripper. Using the extent, state of coverage, position and/or orientation of the particular good 14, the statistical model infers a set of control data, which is transmitted to a control system 16 for controlling the robotic arm 13. The gripper grasps the packaged good 14 and initially rotates it by an angle of rotation 18 relative to the essentially horizontal surface of the continuous conveyor 11. The robotic arm 13 then moves the gripper and, with that, the particular good 14 in a pulling, essentially horizontal and singulating movement 19 according to the set of control data, without lifting the particular good 14. The movement 19 ends on a second continuous conveyor 12, which removes the particular goods 14 together with other packaged goods 20 to be removed.

1. A method for singulating packaged goods (10, 14, 20) by means of a robotic arm (13), comprising the following steps:
a. creating a matrix of measured values of the packaged goods (10, 14) by means of at least one sensor (17);
b. determining an expansion, a state of coverage, a position or an orientation of a particular good (14) of the packaged goods (10, 14, 20) by means of inference with a statistical model or by means of an approximation method with entry of the matrix of measured values;
c. creating a set of control data for the robotic arm (13), taking into account the expansion, state of coverage, position or orientation of the particular good (14);
d. gripping the particular good (14) by means of the robotic arm (13) according to the set of control data; and
e. singulating the particular good (14) from the other packaged goods (10) with a pulling and singulating movement (19) according to the set of control data by means of the robotic arm (13).

2. The method according to claim 1, wherein
the movement (19) essentially taking place horizontally in step e.

3. The method according to claim 1, wherein
the packaged goods (10, 20) or the particular good (14) are transported before, during or after steps a. to e.

4. The method according to claim 3, wherein
the number of packaged goods delivered (10) and the number of packaged goods removed (20) is measured and, in the event that the number of packaged goods delivered (10) is greater than the number of packaged goods removed (20), the transport of the packaged goods (10), in particular the delivery, being interrupted, the transport of the packaged goods (10), in particular the removal, being increased or the delivery and the removal being matched to each other.

5. The method according to claim 3, wherein
the robotic arm (13) is moved at a speed relative to the speed of transport of the packaged goods (10, 20).

6. The method according to claim 1, wherein
the particular good (14) is rotated on the substantially horizontal plane by an angle of rotation (18) or tilted by a degree of tilt before or during step e.

7. The method according claim 1, wherein
the particular article (14) is turned one or more times before or during step e.

8. The method according to claim 1, wherein at least one handling property of the particular good (14) is determined by means of querying the matrix of measured values, a section of the matrix of measured values or another measured value of another sensor in a database or inference with the or another statistical model, the handling property being a target address, a grip strength, a point of contact, an orientation, a selection of a gripper, a pulling speed or a pulling strength.

9. The method according to claim 1,
wherein the steps of the method take place continuously or in discrete time.

10. The method according to claim 1,
wherein in step b. the extent, the state of coverage, the position or the orientation of at least two detected goods (14) is determined from the packaged goods (10, 14) by means of inference with the or a further statistical model with entry of the measured value matrix and a particular good (14) is selected from the packaged goods (10, 14).

11. The method according to claim 1, the method comprising another step f:
evaluating the singulation and obtaining an evaluation.

12. A device (21) for singulating packaged quality (10, 14, 20), comprising at least one robotic arm (13), at least one sensor (17) and one computer system (15),
wherein
the device (21) is configured to carry out the method according to claim 1, the computer system (15) comprising a computer-readable storage medium comprising the statistical model for executing step b. and at least one data processing device for executing steps b., c., d. or e.

13. The device (21) according to claim 12, wherein
the sensor (17) is part of an image acquisition device, 3D camera, a lidar, a radar, a tactile sensor system, a spectrometer, an ultrasonic measuring device, an X-ray device, a distance measuring device or a refractometer.

14. The device (21) according to claim 12,
wherein
the device (21) comprises another sensor being a light sensor, a force torque sensor, a vacuum sensor, a force sensor, a rotary encoder, a torque sensor, of a pressure sensor, a barcode scanner, an RFID scanner, or a measuring device, a thermometer, an explosives measuring device, a hazard measuring device, a humidity measuring device or a scale.

15. The device (21) according to claim 12,
wherein
the robotic arm (13) has one axis or multiple axes.

16. The device (21) according to claim 12,
wherein
the device (21) comprises at least one continuous conveyor (11, 12) or a load carrier.

17. The device (21) according to claim 12,
wherein
the device (21) comprises a provision surface.

18. The device (21) according to claim 12,
wherein
the computer system (40) comprises an interface (41) or a network connection (42).

19. The device (21) according to claim 12,
wherein
the device (21) is a parcel sorting system and the packaged goods are parcels, small parcels, postal items, documents sent by post, letters sent by post, luggage, boxes, crates, cartons, boxes or bulky goods.

20. A computer program product, comprising sections of software code that are developed in such a way that a method according to claim 1 can be carried out by at least one processor.
